(19) United States
(12) Patent Application Publication
(10) Pub. No.: US 2016/0292115 A1
(43) Pub. Date: Oct. 6, 2016

(54) Methods and Apparatus for IO, Processing and Memory Bandwidth Optimization for Analytics Systems

(71) Applicant: Integrated Device Technology, Inc., San Jose, CA (US)

(72) Inventor: Mohammad Shahanshah Akhter, Ottawa (CA)

(21) Appl. No.: 14/673,724

(22) Filed: Mar. 30, 2015

(51) Int. Cl. G06F 13/40; G06F 13/42; G06T 1/20

(52) U.S. Cl. CPC G06F 13/4027; G06T 1/20; G06F 13/4221

(57) ABSTRACT

Methods and Apparatus for IO, Processing and Memory Bandwidth Optimization for Analytics Systems has been disclosed. In one implementation a plurality of cards each having one or more GPU+CPU are interconnected via RapidIO.

### RELATED APPLICATION

The present Application for Patent is related to U.S. patent application Ser. No. ______ titled “Methods and Apparatus for Efficient Network Analytics and Computing Card” filed Mar. 30, 2015 pending by the same inventor which is hereby incorporated herein by reference.

### FIELD OF THE INVENTION

The present invention pertains to optimization for analytics systems. More particularly, the present invention relates to Methods and Apparatus for IO, Processing and Memory Bandwidth Optimization for Analytics Systems.

### BACKGROUND OF THE INVENTION

In current data analytics and computing systems, it is difficult to balance the memory bandwidth with the IO and computation capability available in the processing unit.

FIG. 1 at 100 shows a current system where GPU cards are connected to a server card using PCIe. At 102 is a GPU card (with a GPU), at 104 a host server card (with a host CPU), at 106 a PCIe interconnect.

Current systems off-load computations to the GPU.

Data is off-loaded to the GPU over the PCIe interface from a server host CPU.

Due to limitations of maximum PCIe bandwidth between a Host CPU and the GPU card, even if the GPU has higher memory bandwidth and processing capability, enough data can't be exchanged between the host processor and the GPU to work on and the GPU processing capability can't be maximized.

Due to PCIe root-complex topology, the system is not scalable and is limited to a small number of nodes.

FIG. 2 at 200 shows a current system where multiple GPUs are connected using NVLink. NVLink provides a point-to-point connection between GPUs, however an NVLink based switched fabric device does not exist for clustering a large number of GPUs with low latency and flow control. At 202 is a GPU card, at 204 a GPU card, at 206 NVLink, at 208 a host server card, and at 210 a PCIe interface.

In some cases GPUs are connected with NVLink, however NVLink based switched fabric device does not exist; therefore it is not possible to scale the system to a large number of GPU nodes with low latency with flow control.

This presents a technical problem for which a technical solution using a technical means is needed.

### BRIEF DESCRIPTION OF THE DRAWINGS

The invention is illustrated by way of example and not limitation in the figures of the accompanying drawings.

FIG. 1 shows a current system where GPU cards are connected to a server card using PCIe.

FIG. 2 shows a current system where multiple GPUs are connected using NVLink.

FIG. 3 shows one embodiment of the invention showing a PCIe card with a SATA interface, a PCIe host interface, an Ethernet interface, and a RapidIO interface.

FIG. 4 shows one embodiment of the invention showing a PCIe card with on-board storage, a PCIe host interface, an Ethernet interface, and a RapidIO interface.

FIG. 5 illustrates two embodiments of the invention showing an example server motherboard.

FIG. 6, FIG. 7, FIG. 8, FIG. 9, FIG. 10, and FIG. 11 each illustrates an embodiment of the invention showing a network processing card.

FIG. 12, FIG. 13, FIG. 14, and FIG. 15 each illustrates an embodiment of the invention showing a compute card.

FIG. 16, and FIG. 17 each illustrates an embodiment of the invention showing a switching arrangement to aggregate multiple compute cards.

FIG. 18 illustrates one embodiment of the invention showing an example computing module having multiple GPUs (each with an integrated host processor) connected using PCIe-RapidIO/RapidIO fabric.

FIG. 19 illustrates one embodiment of the invention showing a network processing card connected to a host CPU.

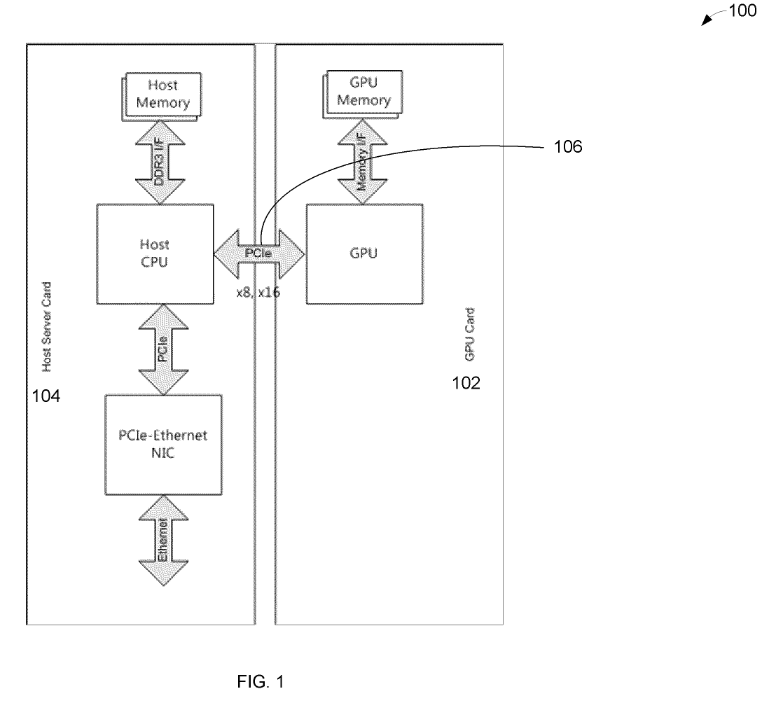

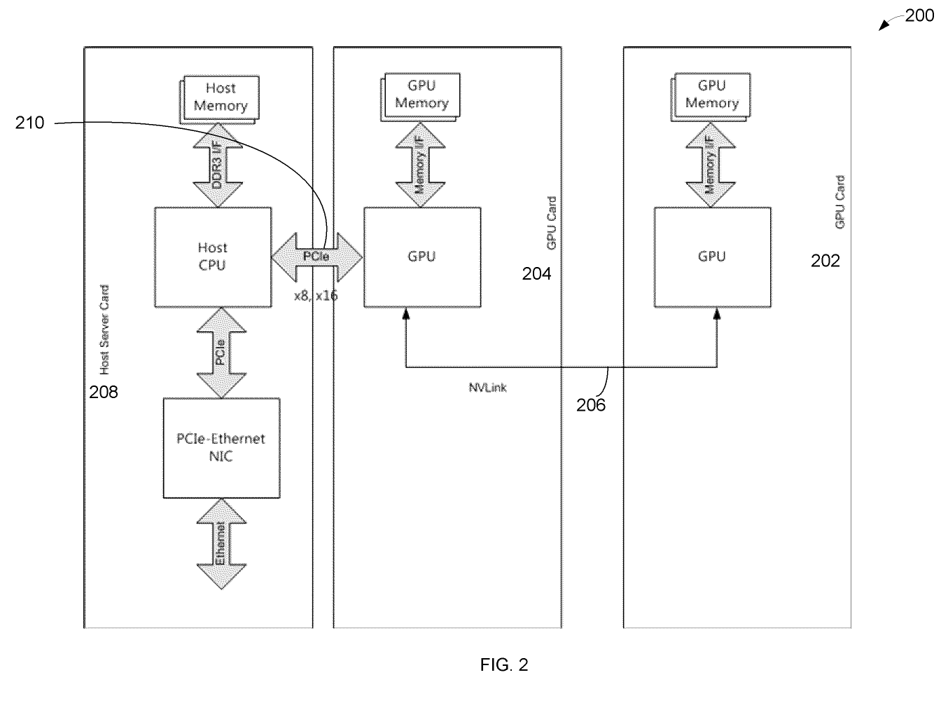

### DETAILED DESCRIPTION

In one embodiment the invention provides scale-out fault-tolerant balanced computing and analytics system in terms of GPU (Graphics Processing Unit) memory bandwidth, IO (Input/Output), processing, power consumption, and cost.

In one embodiment the invention supports real-time network and data analytics.

In one embodiment the invention utilizes multiple GPUs with an integrated host processor.

In one embodiment of the invention multiple GPUs are connected with RapidIO low latency interconnects.

In one embodiment the invention utilizes PCIe-RapidIO NIC (network interface controller) to maximize bandwidth utilization per GPU using a ×4 PCIe port on the GPU.

In one embodiment of the invention RapidIO fabric enables communication between GPUs in other modules leading to a scalable solution. RapidIO fabric together with PCIe-RapidIO NIC allows a highly scalable multi-root solution.

In one embodiment the invention supports various network topologies (2D, 3D, Torus, etc.) through RapidIO fabric and offers dynamic switching using packet based protocol.

In one embodiment the invention supports local caching and boot based on eMMC (embedded multi media card).

In one embodiment of the invention external storage is provided with SATA (Serial Advanced Technology Attachment).

In one embodiment of the invention a PCIe switch is used to provide connectivity with a host server.

In one embodiment of the invention a network function and Ethernet connectivity is provided via a CPU with integrated 10 Gb/1 Gb/RapidIO/PCIe processor.

In one embodiment of the invention RapidIO fabric and PCIe-RapidIO provides low latency RDMA (remote direct memory access) with flow control and multi-cast capability with different baud-rates to optimize memory to memory communication, fabric utilization and power consumption.

In one embodiment the invention enables a balanced system in terms of processing, GPU memory bandwidth, and I/O.

In one embodiment the invention provides scale-out capability with inter-GPU connectivity through RapidIO.

In one embodiment the invention enables a very high density network analytics appliance.

In one embodiment the invention allows very low latency links between GPUs (with integrated CPU) to create large scale-out system.

In one embodiment the invention provides fault-tolerant capability with RapidIO fabric between nodes.

In one embodiment the invention supports real-time network traffic and data analytics with traditional and emerging data base systems.

In one embodiment the invention works with a traditional standard server.

In one embodiment the invention utilizes multiple GPUs with integrated host processor.

In one embodiment of the invention multiple GPUs are connected with a RapidIO low latency interconnect.

In one embodiment of the invention RapidIO fabric together with PCIe-RapidIO NIC allows a highly scalable multi-root system.

In one embodiment the invention supports various network topologies (2D, 3D, Torus etc.)

In one embodiment the invention offers dynamic switching using packet based protocol.

In one embodiment of the invention local caching and boot is provided via eMMC.

In one embodiment of the invention external storage is provided via SATA.

In one embodiment of the invention a PCIe switch is used to provide connectivity with a host server.

In one embodiment the invention network functionality and Ethernet connectivity are provided via a CPU having integrated on the same chip a 10 Gb/1 Gb/RapidIO/PCIe processor.

In one embodiment the invention a RapidIO fabric and PCIe-RapidIO provides low latency RDMA and multi-cast capability with different baud-rates to optimize memory to memory communication, fabric utilization and power consumption.

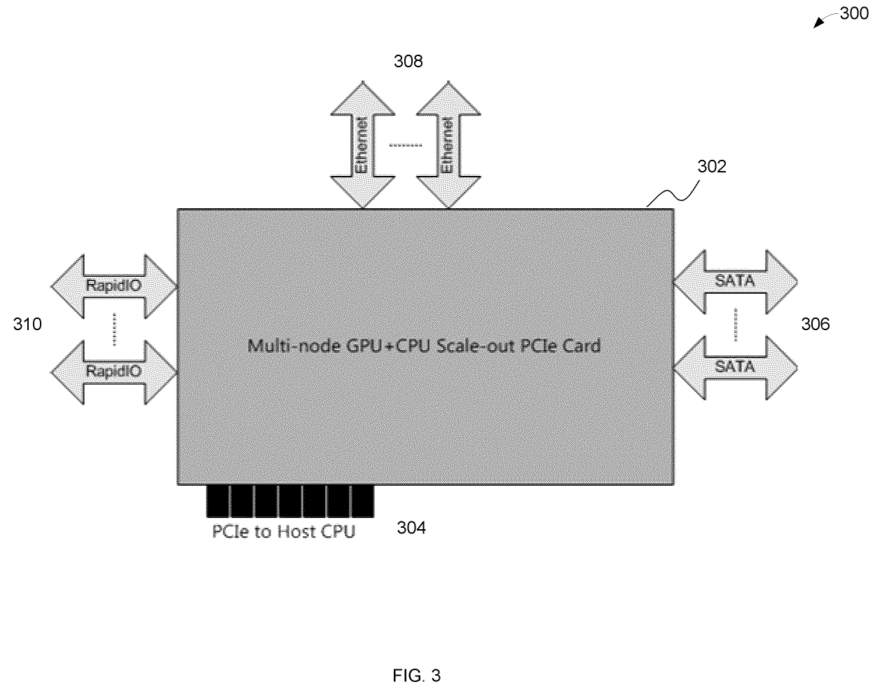

FIG. 3 illustrates, generally at 300, one embodiment of the invention showing a PCIe card 302, with SATA storage interface 306, a PCIe 304 host interface to connect to a host server board, Ethernet for network connection 308, and RapidIO 310 for inter-card scalability and low latency data distribution. In this embodiment, the SATA 306 can connect to storage that is not located on the PCIe card 302.

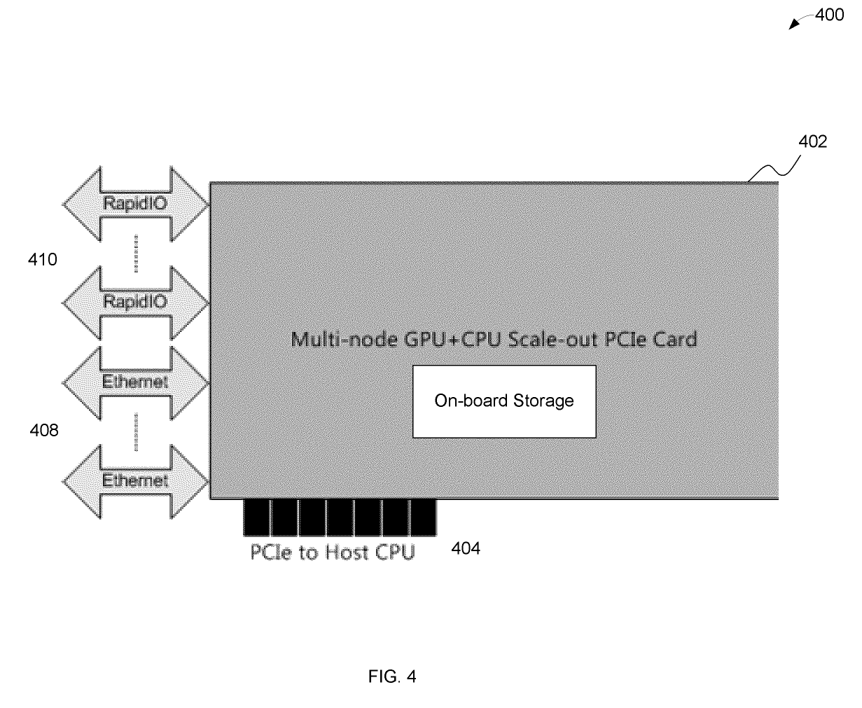

FIG. 4 illustrates, generally at 400, one embodiment of the invention showing a PCIe card 402 with on-board storage, a PCIe 404 host interface to connect to a host server board, Ethernet 408 for network connection, and RapidIO 410 for inter-card scalability and low latency data distribution.

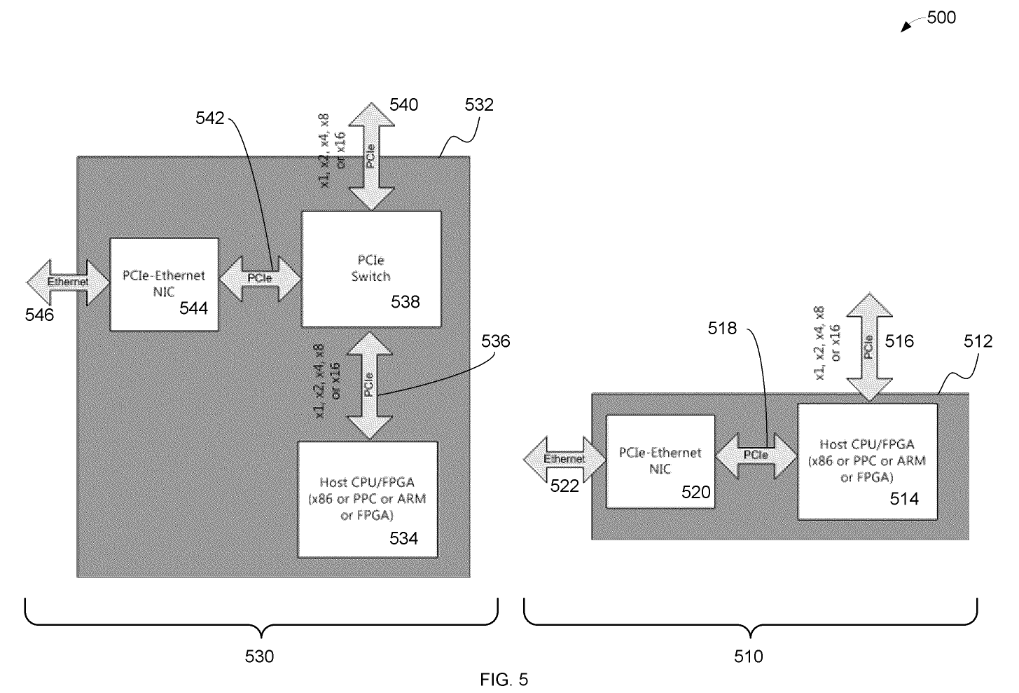

FIG. 5 illustrates, generally at 500, two embodiments of the invention showing an example server motherboard. A server and network card may include memory and flash (not shown explicitly). At 510 is one embodiment having a card 512 with a host CPU 514, a first PCIe interface 516, a second PCIe interface 518 connected to a PCIe-Ethernet NIC 510, and an Ethernet interface 522. At 530 is another embodiment having a card 532 with a host CPU 534, a first PCIe interface 536, a PCIe switch 538 which is also connected to a second PCIe interface 540 and a third PCIe interface 542. At 544 is a PCIe-Ethernet NIC, and an Ethernet interface 546.

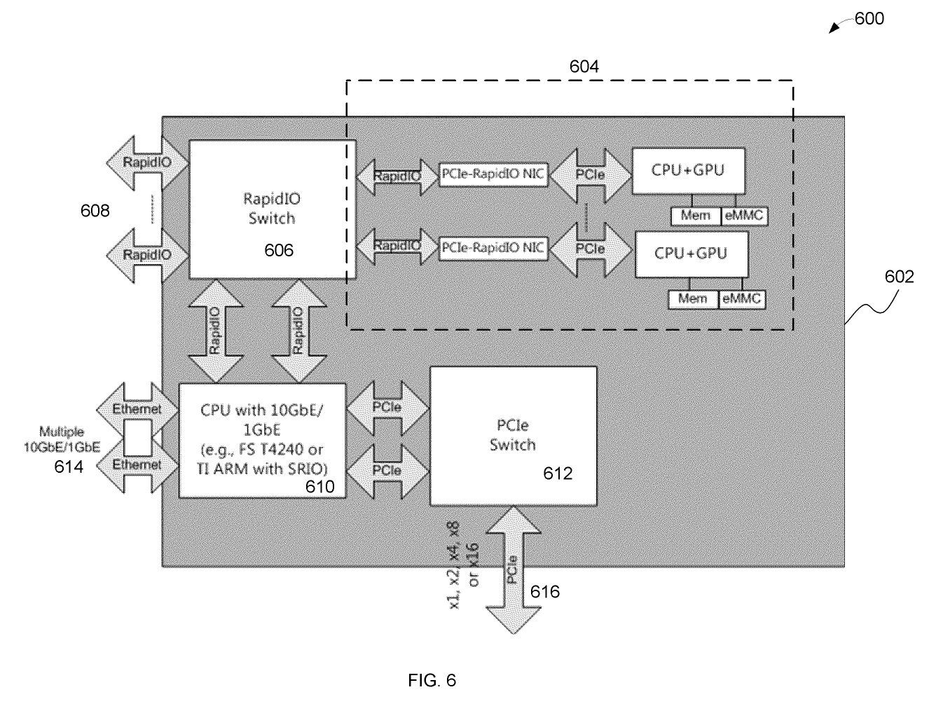

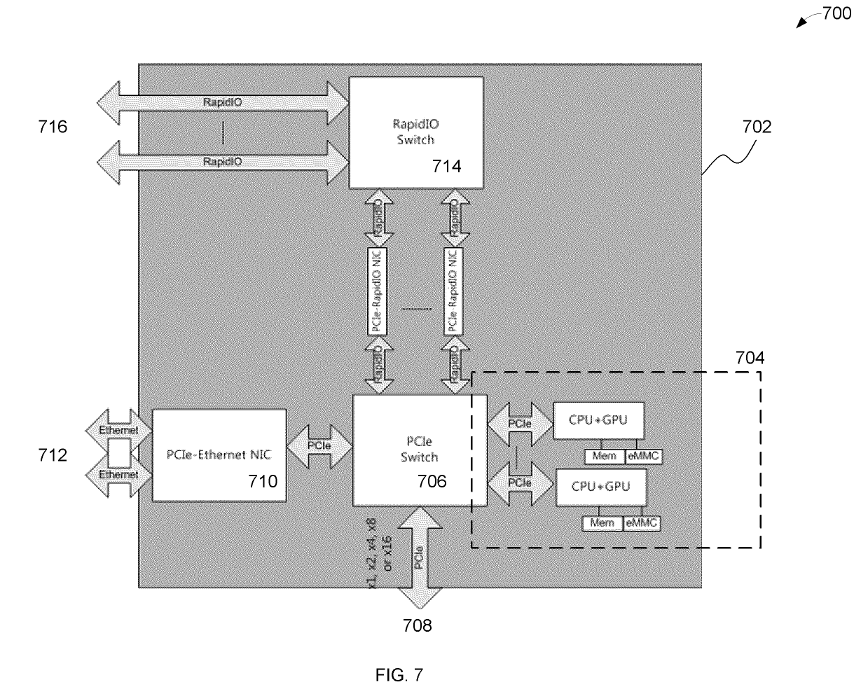

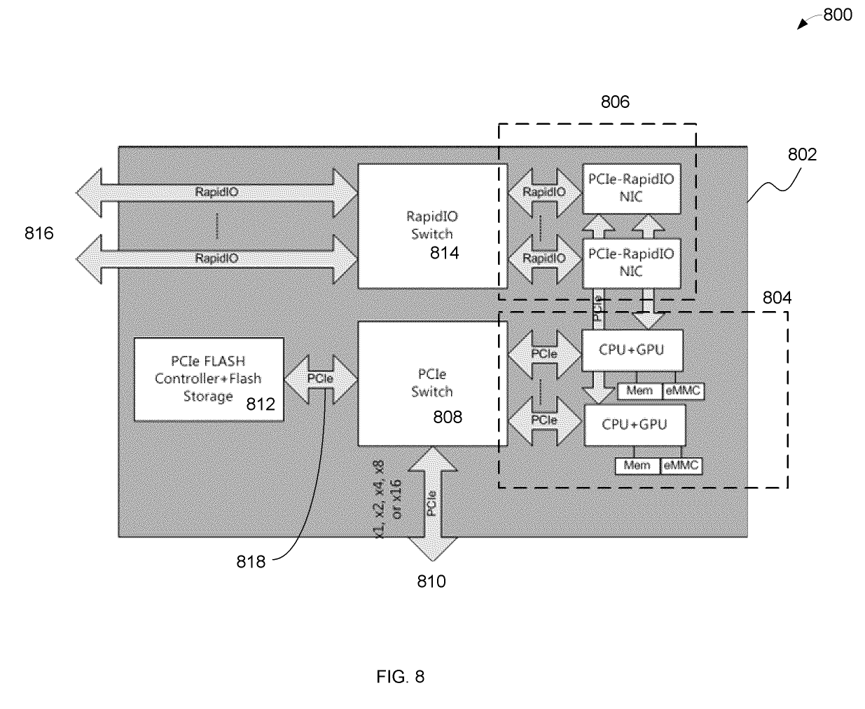

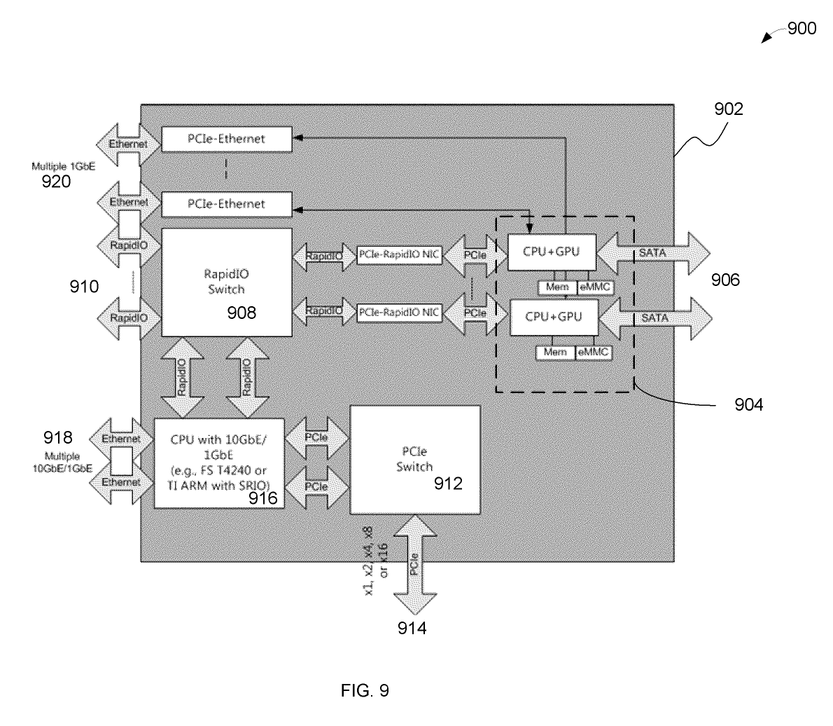

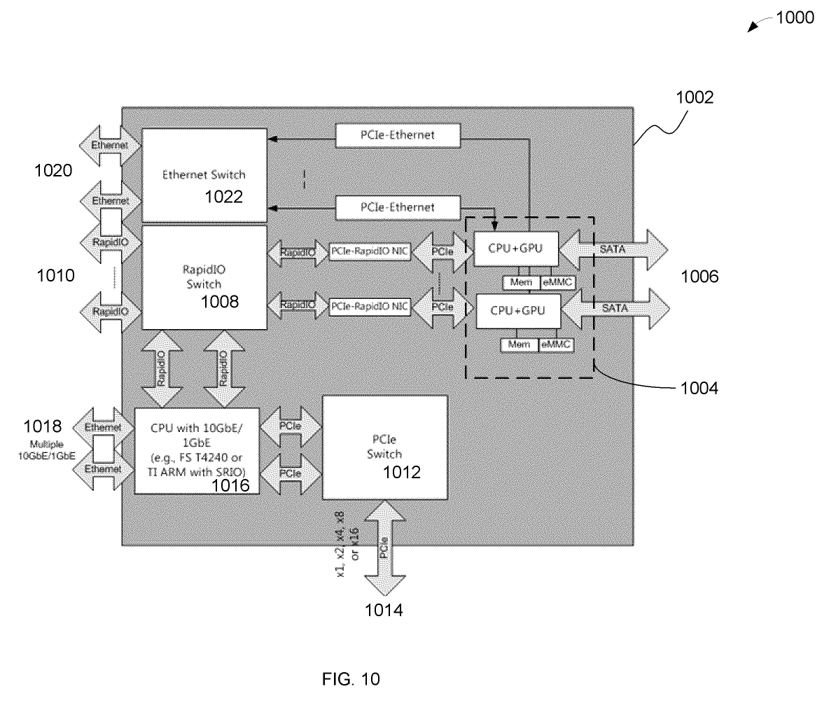

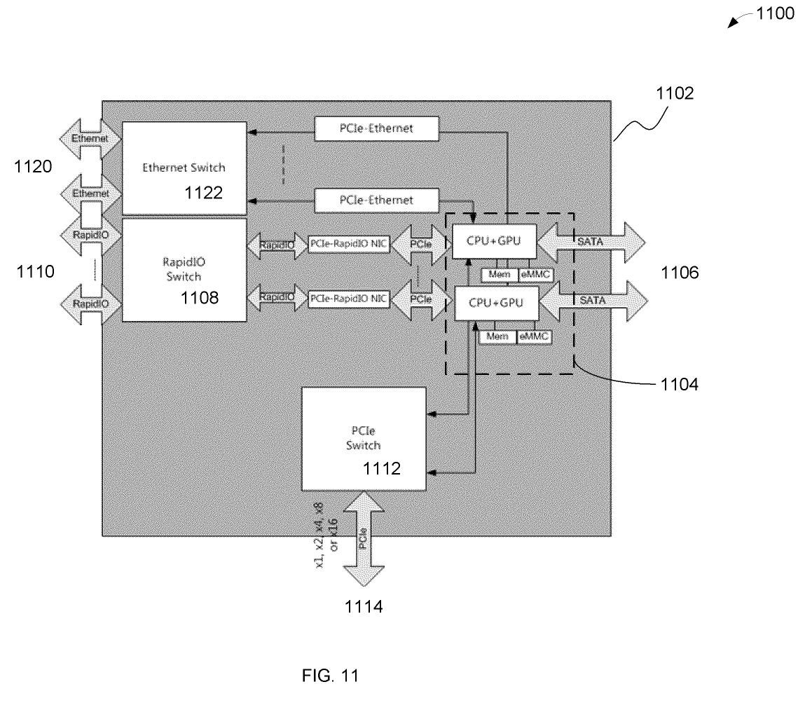

FIG. 6 illustrates, generally at 600, one embodiment of the invention showing a network processing card 602. At 604 are multiple CPU+GPU each connected to memory and eMMC and communicating via PCIe-RapidIO NIC to RapidIO to a RapidIO switch 606. RapidIO switch 606 connects to multiple RapidIO ports 608, and via multiple RapidIO ports to a CPU 610 with multiple Ethernet 614 interfaces. CPU 610 is also connected to multiple PCIe buses to PCIe switch 612 which interfaces to a PCIe bus 616. The network processing card incorporates a PCIe switch to interconnect multiple CPU+GPU and PCIe-to-Ethernet NIC. The PCIe switch needs limited multi-root connection, RapidIO and PCIe-RapidIO provides connection directly to CPU+GPU and scales across cards with multi-root connectivity. The RapidIO switch is used to scale across multiple cards. The CPU with 10 GbE provides network connectivity while providing hardware off-loads for various network functions.

FIG. 7 illustrates, generally at 700, one embodiment of the invention showing a network processing card 702. At 704 are multiple CPU+GPU each connected to memory and eMMC and communicating via PCIe to a PCIe Switch 706. PCIe Switch 706 connects via PCIe to PCIe-Ethernet NIC 710 to multiple Ethernet ports 712. PCIe Switch 706 also connects via multiple RapidIO and PCIe-RapidIO NIC to RapidIO Switch 714. RapidIO Switch 714 also connects to multiple RapidIO 716. In this illustrated embodiment, the Network Processing Card incorporates a PCIe switch to interconnect multiple CPU+GPU and PCIe-to-Ethernet NIC. PCIe NTB (non-transparent bridging) switches are needed for on-board multi-root connection. RapidIO and PCIe-RapidIO provides multi-root connection across cards. A RapidIO switch is used to scale across multiple cards and distribute traffic.

FIG. 8 illustrates, generally at 800, one embodiment of the invention showing a network processing card 802 which incorporates on-board storage 812 using a PCIe interface 818. At 804 are multiple CPU+GPU each connected to their own memory, and eMMC and communicating via PCIe to a PCIe Switch 808, and communicating via PCIe with PCIe-RapidIO NIC and then RapidIO to RapidIO Switch 814 which connects to multiple RapidIO 816. PCIe Switch 808 communicates to a host server via PCIe 810, and via PCIe 818 to on board memory 812.

FIG. 9 illustrates, generally at 900, one embodiment of the invention showing a network processing card 902. At 904 are multiple CPU+GPU each connected to memory and eMMC and communicating via a SATA port 906, and via PCIe to PCIe-RapidIO NIC then through RapidIO to RapidIO Switch 908. RapidIO Switch 908 communicates with RapidIO 910, and via RapidIO to CPU with Ethernet 916. CPU with Ethernet 916 communicates via PCIe with PCIe Switch 912 that communicates via PCIe 914. CPU with

Ethernet 916 also communicates via Ethernet 918. Multiple CPU+GPU 904 also communicated with PCIe-Ethernet to Ethernet 920. In this illustrated embodiment there is incorporated a SATA link 906 for external storage using SATA interface 906 from multiple CPU+GPU 904, also Network connection 920 is provided directly to CPU+GPU 904

FIG. 10 illustrates, generally at 1000, one embodiment of the invention showing a network processing card 1002. At 1004 are multiple CPU+GPU each connected to memory and eMMC and communicating via a SATA port 1006, and via PCIe to PCIe-RapidIO NIC then through RapidIO to RapidIO Switch 1008. RapidIO Switch 1008 communicates with RapidIO 1010, and via RapidIO to CPU with Ethernet 1016 (CPU Block). CPU with Ethernet 1016 communicates via PCIe with PCIe Switch 1012 that communicates via PCIe 1014. CPU with Ethernet 1016 also communicates via Ethernet 1018. Multiple CPU+GPU 1004 also communicates with PCIe-Ethernet to Ethernet Switch 1022 which communicates with Ethernet 1020. In this illustrated embodiment there is incorporated a SATA link 906 for external storage using SATA interface 1006 from multiple CPU+GPU 1004, it also incorporates an Ethernet switch 1022 for network traffic load distribution.

FIG. 11 illustrates, generally at 1100, one embodiment of the invention showing a network processing card 1102. At 1104 are multiple CPU+GPU each connected to memory and eMMC and communicating via a SATA port 1106, and via PCIe to PCIe-RapidIO NIC then through RapidIO to RapidIO Switch 1108. RapidIO Switch 1108 communicates with RapidIO 1110. CPU+GPU 1104 communicate with PCIe Switch 1112 that communicates via PCIe 1114. CPU+GPU 1104 also communicates via PCIe-Ethernet to Ethernet Switch 1122 which communicates with Ethernet 1120. In this illustrated embodiment there is incorporated a SATA link 1106 for external storage using SATA interface from CPU+GPU. This embodiment also incorporates an Ethernet switch 1122 for network traffic load distribution. This allows direct communication between CPU+GPU 1104 and host server board (via 1114) through PCIe switch 1112. A small port count PCIe switch 1112 needs a small number of multi-root ports for on-board connection. The RapidIO 1110 allows traffic distribution and low latency links between other Network processing cards.

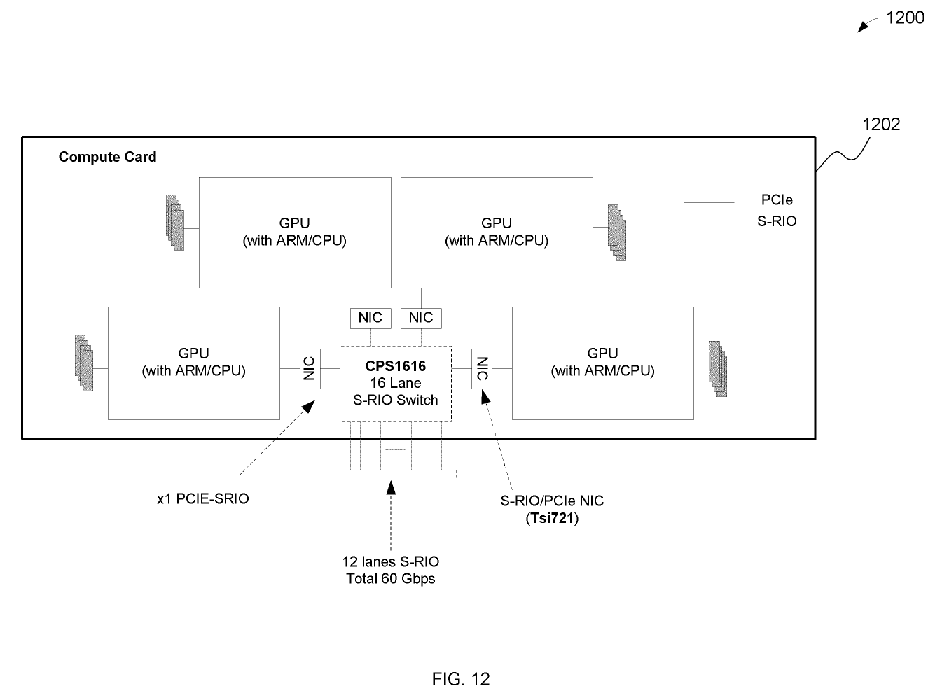

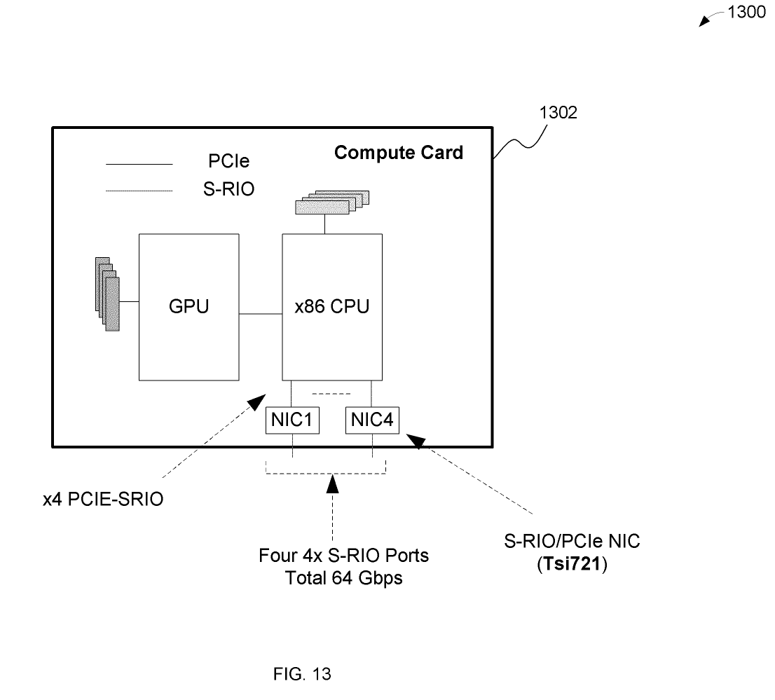

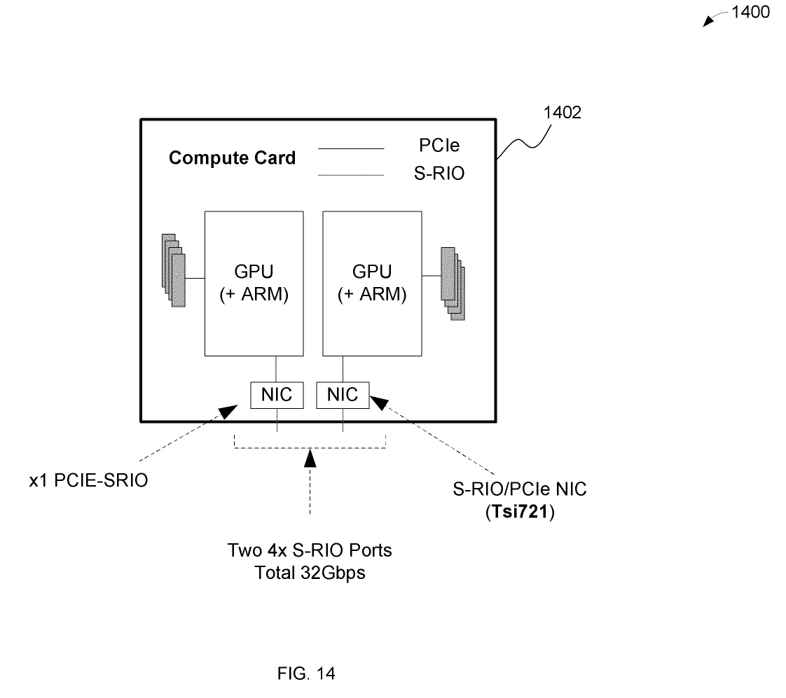

FIG. 12 illustrates, generally at 1200, one embodiment of the invention showing a compute card 1202. The compute card 1202 is an example of the GPU modules in this case a GPU with ARM or other integrated CPU.

FIG. 13 illustrates, generally at 1300, one embodiment of the invention showing a compute card 1302. The compute card 1302 is an example of the GPU modules in this case a GPU (for example, K20, K40, K80, etc.) with ×86 CPU.

FIG. 14 illustrates, generally at 1400, one embodiment of the invention showing a compute card 1402. The compute card 1402 is an example of the GPU modules in this case a GPU (with integrated ARM or other CPU) as a two node system to reduce power/size/cost.

FIG. 15 illustrates, generally at 1500, one embodiment of the invention showing a compute card 1502. The compute card 1502 is an example of the GPU modules in this case a GPU with ×86 CPU (PCIe exposed instead of S-RIO (Serial RapidIO)—for use with switching arrangement, for example as shown in FIG. 17).

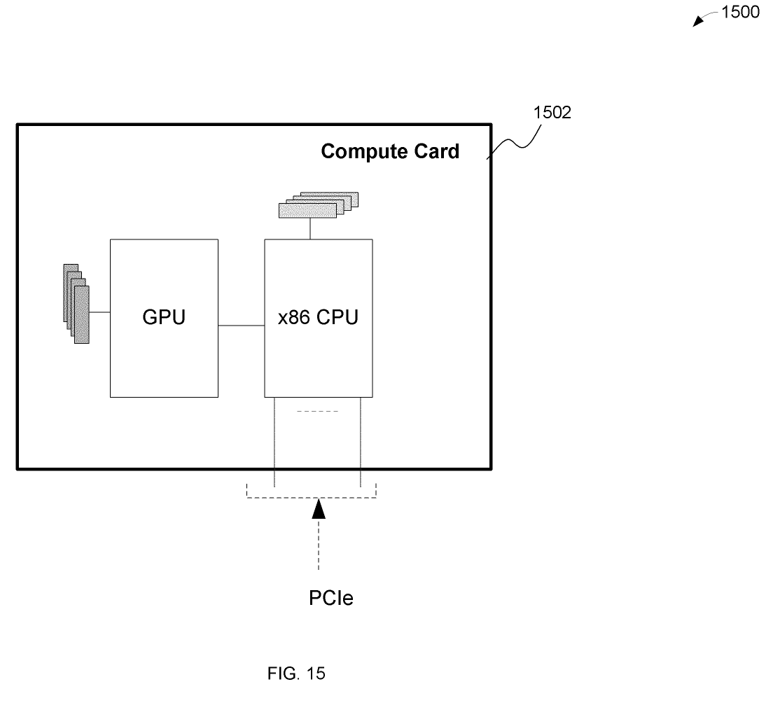

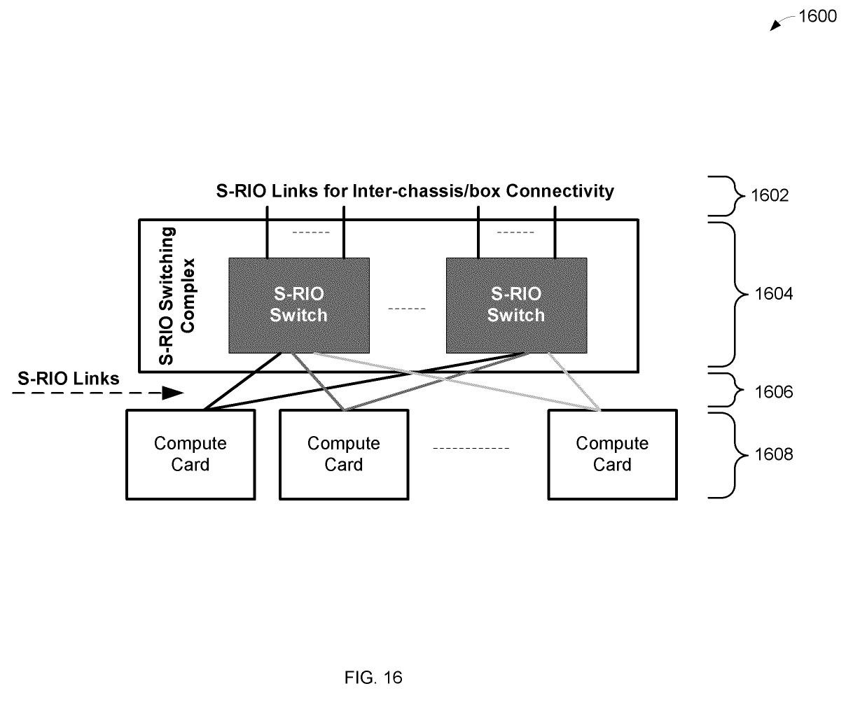

FIG. 16 illustrates, generally at 1600, one embodiment of the invention showing a switching arrangement to aggregate multiple compute cards. In this embodiment the RapidIO Port is exposed. At 1608 are the compute cards, at 1606 are S-RIO links, at 1604 is the S-RIO switching complex, and at 1602 are the S-RIO linke for inter-chassis/box connectivity.

FIG. 17 illustrates, generally at 1700, one embodiment of the invention showing a switching arrangement to aggregate multiple compute cards. In this embodiment the PCIe Port is exposed. At 1708 are the compute cards, at 1706 are PCIe links, at 1704 is the PCIe-S-RIO switching complex, and at 1602 are the S-RIO linke for inter-chassis/box connectivity.

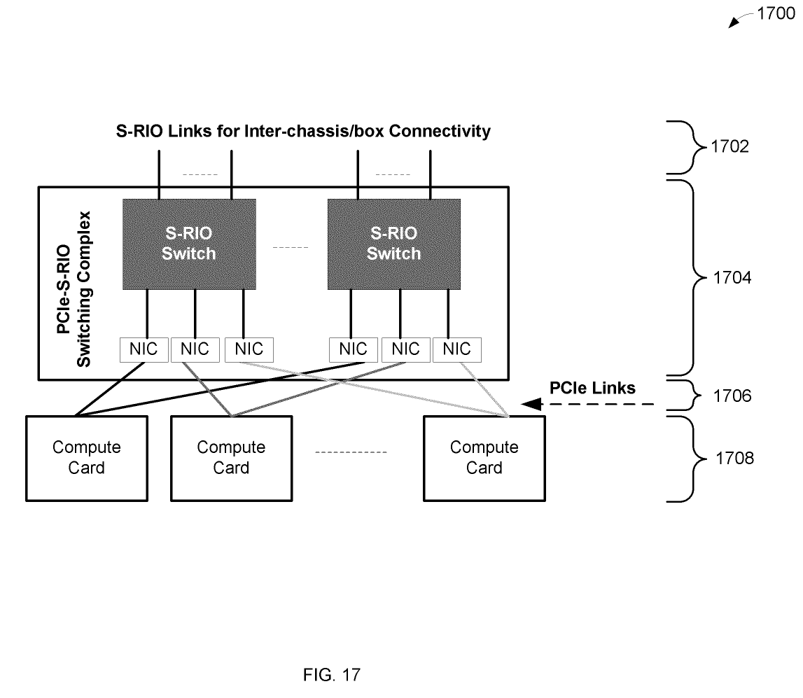

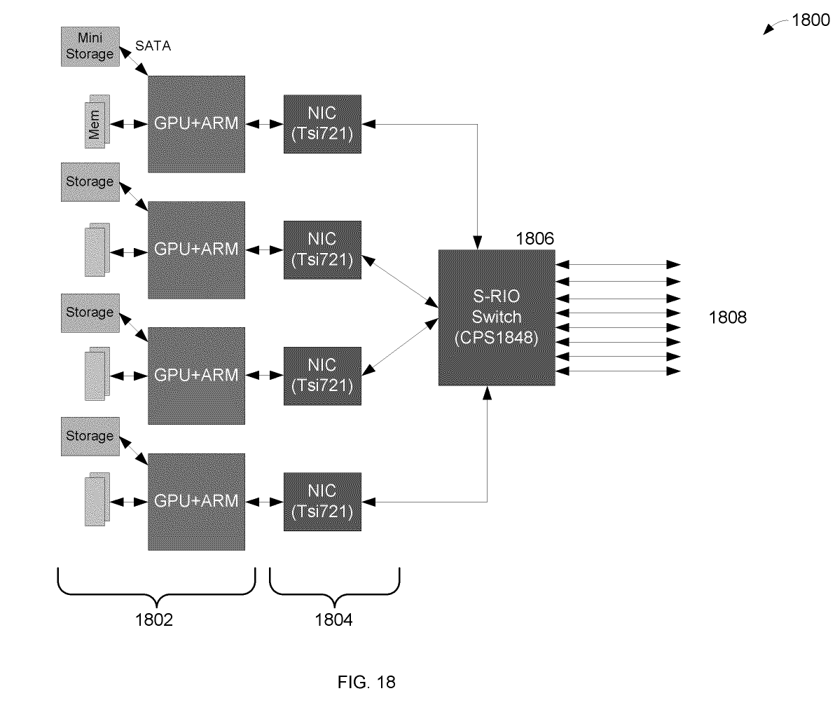

FIG. 18 illustrates, generally at 1800, one embodiment of the invention showing an example computing module having multiple GPUs (each with an integrated host processor) connected using PCIe-RapidIO/RapidIO fabric. At 1802 are GPU with CPU (ARM shown) with storage (SATA and MiniStorage), and memory (mem), at 1804 are interconnects using NICs, at 1806 is the S-RIO switch which can communicate via 1808.

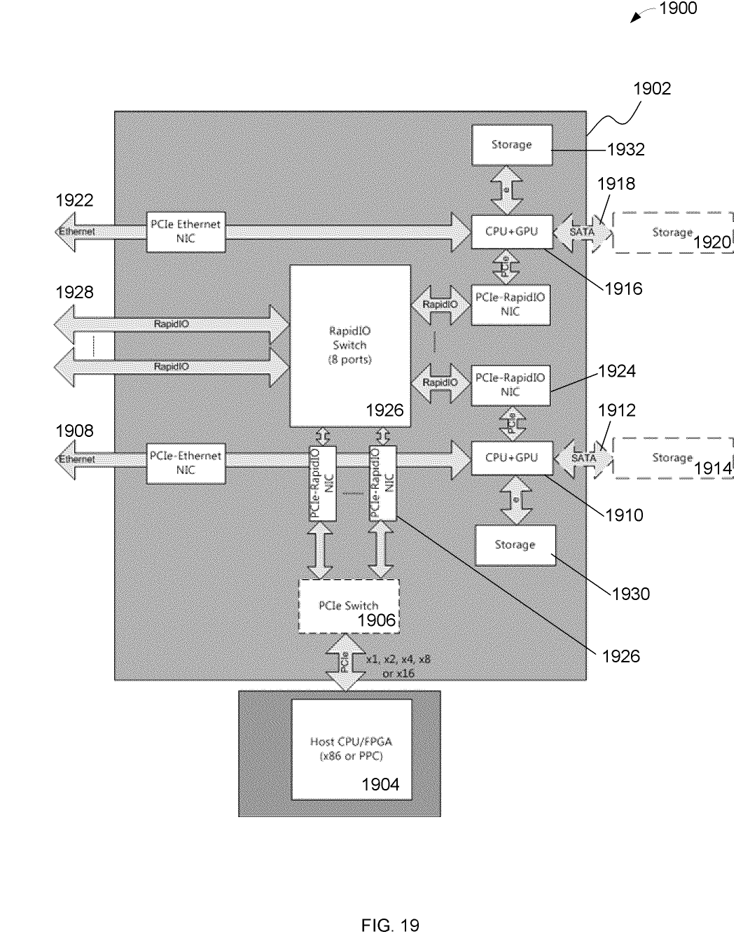

FIG. 19 illustrates, generally at 1900, one embodiment of the invention showing a network processing card 1902. At 1904 is a Host. At 1906 is an optional PCIe Switch. At 1908 is an Ethernet interface that communicates with CPU+GPU at 190. At 1912 is an optional SATA interface connected to an optional external Storage 1914. At 1916 is another CPU+GPU which can communicate via with Ethernet port 1922. At 1918 is an optional SATA interface. At 1920 is optional external Storage (i.e. Storage 1920 not located on network processing card 1902. At 1924 is a PCIe-RapidIO NIC and at 1926 is a RapidIO Switch. At 1930 and 1932 are on-board Storage connected respectively to CPU+GPU 1910 and 1916. Storage 1930 and 1932 can be any combination of, for example, memory, eMMC, etc.

In one embodiment, for example, as illustrated in FIG. 19, a RapidIO Direct connection with the GPU is used. For example, data and control information can be exchanged between the Host CPU/FPGA 1904 and GPU 1910 through PCIe-RapidIO NIC 1924 and RapidIO Switch 1926.

In one embodiment, for example, as illustrated in FIG. 19, the PCIe switch 1906 is optional, that is it could be removed, and in this case, the PCIe-RapidIO NICs 1926 are directly connected to the Host CPU/FPGA 1904.

In one embodiment, for example, as illustrated in FIG. 19, the PCIe port in the Host CPU 1904 is bi-furcated, that is a 8× port can be used as two 4× ports.

In one embodiment, for example, as illustrated in FIG. 19, a CPU+GPU 1910 can communicate directly via Ethernet 1908. The CPU+GPU 1910 can also communicate to other cards via RapidIO 1928 through 1926 and 1924. The CPU+GPU 1910 can also communicate to the Host 1904 via RapidIO from 1924 through 1926 and without the PCIe Switch 1906 which is optional to the Host 1904.

In one embodiment, for example, as illustrated in FIG. 19, without the optional features an overall solution is less complex as there are a fewer number of devices that need to be managed.

Thus Methods and Apparatus for IO, Processing and Memory Bandwidth Optimization for Analytics Systems have been described.

Because of the high speed embodiments the present invention requires specialized hardware.

As used in this description “GPU” or similar phrases, such as “Graphics Processing Unit” refers to specialized hardware that is not to be confused with a CPU (central processing unit). One skilled in the art understands that a GPU and CPU are different. For example, but not limited to, a GPU generally has specialized hardware for the efficient processing of pixels and polygons (image processing).

As used in this description “GPU+CPU” or “CPU+GPU” or “CPU/GPU” or similar phrases refers to a CPU and GPU combination. That is, a CPU and GPU are both present in the embodiment and in close physical and electrical proximity. The CPU+GPU may be a combination of a CPU on a different integrated circuit than the GPU, or the CPU+GPU combination may be on a single integrated circuit.

As used in this description “host processor” or similar phrases refers to a CPU and not a GPU.

As used in this description, “one embodiment” or “an embodiment” or similar phrases means that the feature(s) being described are included in at least one embodiment of the invention. References to “one embodiment” in this description do not necessarily refer to the same embodiment; however, neither are such embodiments mutually exclusive. Nor does “one embodiment” imply that there is but a single embodiment of the invention. For example, a feature, structure, act, etc. described in “one embodiment” may also be included in other embodiments. Thus, the invention may include a variety of combinations and/or integrations of the embodiments described herein.

As used in this description, “substantially” or “substantially equal” or similar phrases are used to indicate that the items are very close or similar. Since two physical entities can never be exactly equal, a phrase such as “substantially equal” is used to indicate that they are for all practical purposes equal.

It is to be understood that in any one or more embodiments of the invention where alternative approaches or techniques are discussed that any and all such combinations as may be possible are hereby disclosed. For example, if there are five techniques discussed that are all possible, then denoting each technique as follows: A, B, C, D, E, each technique may be either present or not present with every other technique, thus yielding 2̂5 or 32 combinations, in binary order ranging from not A and not B and not C and not D and not E to A and B and C and D and E. Applicant(s) hereby claims all such possible combinations. Applicant(s) hereby submit that the foregoing combinations comply with applicable EP (European Patent) standards. No preference is given any combination.

Thus Methods and Apparatus for IO, Processing and Memory Bandwidth Optimization for Analytics Systems has been described.

What is claimed is:

1. A method for providing a scalable GPU system, the method comprising:
(a) providing multiple GPUs each having an integrated host processor on a first PCIe card;
(b) providing multiple SATA interfaces on said first PCIe card;
(c) providing multiple Ethernet interfaces on said first PCIe card; and
(d) providing multiple RapidIO interfaces on said first PCIe card.

2. The method of claim 1 further comprising:
a second PCIe card having the same configuration as said first PCIe card (a)-(d) in claim 1; and
using said multiple RapidIO interfaces on said first PCIe card to connect to said multiple RapidIO interfaces on said second PCIe card in said scalable GPU system.

3. The method of claim 1 further comprising providing on-board storage on said first PCIe card.

4. The method of claim 1 wherein said multiple SATA interfaces connect to storage not located on said first PCIe card.

5. A network processing card comprising:
multiple CPU+GPU each connected to its own memory and its own eMMC on said network processing card; and
said multiple CPU+GPU each connected to its own PCIe on said network processing card.

6. The network processing card of claim 5 wherein said each own PCIe is connected to its own PCIe-RapidIO NIC on said network processing card.

7. The network processing card of claim 5 further comprising a RapidIO switch on said network processing card, said RapidIO switch connected to each said own PCIe-RapidIO NIC on said network processing card.

8. The network processing card of claim 5 further comprising a PCIe switch on said network processing card, said PCIe switch connected to each said own PCIe on said network processing card.

9. The network processing card of claim 5 further comprising multiple SATA interfaces on said network processing card, each of said multiple SATA interfaces connected to one each of said multiple CPU+GPU on said network processing card, and said each of said multiple SATA interfaces capable of connection to storage not located on said network processing card.

10. The network processing card of claim 9 further comprising for each of said multiple CPU+GPU its own PCIe-Ethernet connection, each of said own PCIe-Ethernet connection connected to an Ethernet switch on said network processing card.

11. The network processing card of claim 7 further comprising said RapidIO switch having a plurality of RapidIO ports for connecting to RapidIO resources located off of said network processing card, and said RapidIO switch having a plurality of RapidIO ports for connecting to RapidIO resources located on said network processing card.

12. The network processing card of claim 11 further comprising a CPU block on said network processing card, said CPU block having a CPU, a plurality of Ethernet ports, a plurality of RapidIO ports, and a plurality of PCIe ports, said plurality of RapidIO ports in communication with said RapidIO switch, said plurality of PCIe ports in communication with a PCIe switch.

13. The network processing card of claim 12 wherein said CPU block plurality of Ethernet ports are for connecting to Ethernet resources located off of said network processing card.

14. The network processing card of claim 13 wherein said PCIe switch is optional and when said PCIe switch is not present on said network processing card then one or more of said CPU block plurality of PCIe ports connects to a PCIe interface to a host computer, said host computer not located on said network processing card.

15. The network processing card of claim 9 further comprising for each of said multiple CPU+GPU on said network processing card a PCIe-Ethernet connection for communication off of said network processing card.

16. The network processing card of claim 7 further comprising one or more host interface PCIe-RapidIO NICs on said network processing card, wherein one or more of said one or more host interface PCIe-RapidIO NICs are connected to said RapidIO switch and a PCIe connector on said network processing card for connection to a host.

17. An apparatus comprising a plurality of compute cards, each of said compute cards having a GPU and CPU thereon, and each of said compute cards having one or more links.

18. The apparatus of claim 17 wherein said one or more links are selected from the group consisting of S-RIO links, PCIe links, and S-RIO and PCIe links.

19. The apparatus of claim 18 further comprising a S-RIO switching complex, said S-RIO switching complex having two or more S-RIO switches, wherein said two or more S-RIO switches are connected to one or more of said compute cards said one or more S-RIO links.

20. The apparatus of claim 19 further comprising a PCIe-S-RIO switching complex, said PCIe-S-RIO switching complex having two or more S-RIO switches each connected to multiple NICs, wherein said multiple NICs are connected to one or more of said compute cards said one or more PCIe links.
